(19) United States
(12) Patent Application Publication
(10) Pub. No.: US 2026/0050907 A1
(43) Pub. Date: Feb. 19, 2026

(54) TRANSACTION CODE ACCOUNT BASED PAYMENT SYSTEM

(71) Applicant: Visa International Service Association, San Francisco, CA (US)

(72) Inventors: Chathura Prabuddha Ganegoda Ganegoda Arachchige, Castle Hill, New South Wales (AU); Fahim Ahmed, Kanakanagar, Bangalore (IN)

(73) Assignee: Visa International Service Association, San Francisco, CA (US)

(21) Appl. No.: 19/102,914

(22) PCT Filed: Aug. 31, 2022
(86) PCT No.: PCT/US2022/075714

§ 371 Date: Feb. 11, 2025

(51) Int. Cl. G06Q 20/32; G06Q 20/38

(52) U.S. Cl. CPC G06Q 20/3276; G06Q 20/326; G06Q 20/383

(57) ABSTRACT

Various systems and methods of anonymously conducting a secured payment transaction between a consumer and a merchant are disclosed. The methods can be carried out at a transaction code computer in communication with an alias directory. According to the method a transaction code computer receives a request for a dynamic transaction code from a merchant computer. The request includes a merchant alias identifier. The transaction code computer queries an alias directory storing merchant information details. The transaction code computer validates the merchant with the alias directory based on the merchant alias identifier. The transaction code computer generates the dynamic transaction code and transmits a response to the request for the dynamic transaction code to the merchant computer.

### TECHNICAL FIELD

Today most of the shopping/purchases occur on e-commerce websites. To process the payment people may pay using a card (Debit/Credit) or by way of personal information details stored on a payment platform. Many people, however, are still not very comfortable storing personal information on any payment platform. Some payment techniques employ the use of static or dynamic quick response codes known under the trade name “QR code” that are scanned by a consumer.

### SUMMARY

In one aspect, the present disclosure provides a method of anonymously conducting a secured payment transaction between a consumer and a merchant. The method is carried out at a transaction code computer in communication with an alias directory. The method includes receiving, by a transaction code computer, a request for a dynamic transaction code from a merchant computer, wherein the request comprises a merchant alias identifier; querying, by the transaction code computer, an alias directory storing merchant information details; validating, by the transaction code computer, the merchant with the alias directory based on the merchant alias identifier; generating, by the transaction code computer, the dynamic transaction code; and transmitting, by the transaction code computer, a response to the request for the dynamic transaction code to the merchant computer. In one aspect, the dynamic transaction code is a dynamic quick response (QR) code.

In other aspects, the request may include transaction currency information or transaction amount information. In other aspects the response comprises a dynamic transaction code identifier, a universal resource locator (URL) for the dynamic transaction code, or an expiry code for the dynamic transaction code.

In other aspects, the method further includes onboarding, by the merchant computer, the merchant information details to the alias directory. In other aspects, onboarding the merchant information details in the alias directory includes receiving, by the alias directory, a merchant payment option selection from the merchant computer; inserting, in the alias directory, account information related to the selected merchant payment option; and inserting, in the alias directory, merchant identification information.

In one aspect, the present disclosure provides a method of anonymously conducting a secured payment transaction between a consumer and a merchant. The method includes receiving, by a merchant website, a shopping cart checkout selection from a consumer device; initializing, by the merchant website, a dynamic transaction code widget; sending, by the dynamic transaction code widget, a merchant alias identifier and shopping cart checkout value to a dynamic transaction code engine; validating, by the dynamic transaction code engine, the merchant alias identifier in an alias directory; generating, by the dynamic transaction code engine, a dynamic transaction code; sending, by the dynamic transaction code engine, the dynamic transaction code to the dynamic transaction code widget; displaying, by the dynamic transaction code widget, the dynamic transaction code on an access device. In one aspect, the dynamic transaction code is a dynamic quick response (QR) code.

In other aspects the method includes scanning, the dynamic transaction code displayed on the access device with a consumer mobile device executing an issuer app. In other aspects, the method includes performing payment, by the consumer mobile device, based on the dynamic transaction code.

In one aspect, the present disclosure provides a method of anonymously conducting a secured payment transaction between a consumer and a merchant. The method includes presenting, by a merchant computer, a dynamic transaction code; scanning the dynamic transaction code by a consumer device executing a mobile app; initiating, by the mobile app, a transaction by sending dynamic transaction code data associated with the dynamic transaction code to an issuer computer; resolving, by the issuer computer, merchant details stored in an alias directory; initiating, by the issuer computer, merchant push payments to a payment processing network computer; and sending, by the payment processing network computer, transaction details to an acquirer computer.

In other aspects, the method includes displaying, by the issuer computer, transaction status on the mobile app. In other aspects, the method includes querying, by the merchant computer, the transaction status via the payment processing network computer. In other aspects, the method includes displaying, by the merchant computer, order confirmation on the consumer device.

In other aspects, the dynamic transaction code is a dynamic quick response (QR) code. In other aspects, the dynamic QR code comprises at least a unique dynamic QR code identifier and a merchant alias identifier. In other aspects the dynamic QR code further includes at least a merchant alias type, a transaction amount, a transaction currency code, a payment option, and an expiry code for the dynamic QR code.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference characters refer to identical or functionally similar elements throughout the separate views, together with the detailed description below, are incorporated in and form part of the specification, and serve to further illustrate aspects of concepts that include the claimed disclosure and explain various principles and advantages of those aspects.

The methods and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a transaction code account based payment system, according to at least one aspect of the present disclosure.

FIG. 2 is a swimlane flow diagram of a transaction executed on the transaction code account based payment system shown in FIG. 1, according to at least one aspect of the present disclosure.

FIG. 3 is a flow diagram of several stages of a transaction executed on the transaction code account based payment system shown in FIG. 1, according to at least one aspect of the present disclosure.

FIG. 4 is a screen displayed on a merchant website, according to at least one aspect of the present disclosure.

FIG. 5 is a mobile device running a mobile app, according to at least one aspect of the present disclosure.

FIG. 6 is a merchant point-of-sale (POS)/point-of-purchase (POP) terminal, according to at least one aspect of the present disclosure.

FIG. 7 is a logic flow diagram of a consumer completing a transaction with a merchant, according to at least one aspect of the present disclosure.

FIG. 8 is an example of a merchant e-commerce website checkout page, according to at least one aspect of the present disclosure.

FIG. 9 illustrates a mobile app payment flow diagram, according to at least one aspect of the present disclosure.

FIG. 10 is a logic flow diagram of a method of anonymously conducting a secured payment transaction between a consumer and a merchant, according to at least one aspect of the present disclosure.

FIG. 11 is a logic flow diagram of a method of anonymously conducting a secured payment transaction between a consumer and a merchant, according to at least one aspect of the present disclosure.

FIG. 12 is a logic flow diagram of a method of anonymously conducting a secured payment transaction between a consumer and a merchant, according to at least one aspect of the present disclosure.

FIG. 13 is a block diagram of a computer apparatus with data processing subsystems or components, according to at least one aspect of the present disclosure.

FIG. 14 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific aspects and examples, some descriptions of terms used herein are provided below.

A “consumer” may include an individual or a user that may be associated with one or more personal accounts and/or consumer devices. The consumer may also be referred to as a cardholder, account holder, or user.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some aspects, the server computer may provide and/or support payment network cloud service.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting aspects, an issuer system may include one or more servers (e.g., one or more authorization servers) for authorizing a payment transaction.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

A “payment network” may refer to an electronic payment system used to accept, transmit, and/or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment device” may refer to any device that may be used to conduct a financial transaction, such as to provide payment information to a merchant. A payment device may be in any suitable form. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. For example, suitable payment devices can be hand-held and compact so that they can fit into a consumer's wallet and/or pocket (e.g., pocket-sized). They may include smart cards, debit devices (e.g., a debit card), credit devices (e.g., a credit card), stored value devices (e.g., a stored value card or “prepaid” card), magnetic stripe cards, keychain devices (such as the Speedpass™ commercially available from Exxon-Mobil Corp.), etc. Other examples of payment devices include cellular or wireless telephones (e.g., a smartphone), personal digital assistants (PDAs), portable computer (e.g. tablet or laptop computer), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. In some non-limiting aspects, a payment device may include an electronic payment device, such as a smartcard, a chip card, integrated circuit card, and/or the like. An electronic payment device may include an embedded integrated circuit and the embedded integrated circuit may include a data storage medium (e.g., volatile and/or non-volatile memory) to store information associated with the payment device, such as an account identifier, a name of the account holder, and/or the like. The payment device may interface with an access device such as a point of sale device to initiate the transaction. In some aspects, a mobile device can function as a payment device (e.g., a mobile device can store and be able to transmit payment credentials for a transaction).

A payment device may be associated with a value such as a monetary value, a discount, or store credit, and a payment device may be associated with an entity such as a bank, a merchant, a payment processing network, or a person. A payment device may be used to make a payment transaction.

An “access device” may refer to a device that receives information from a payment device to initiate a transaction. For example, an access device may be a point of sale device configured to read account data encoded in a magnetic stripe or chip of a card-format portable consumer device. Other examples of access devices include cellular phones, PDAs, personal computers, tablets, handheld specialized readers, set-top boxes, electronic cash registers, automated teller machines (ATMs), virtual cash registers, kiosks, security systems, access systems, and the like. Access devices may use means such as radio frequency (RF) and magnetic stripe readers to interact with a payment device. The access device may be a device located at a merchant's physical location or may be a virtual point of sale such as a web-site that is part of an e-commerce (electronic commerce) transaction. In an e-commerce transaction, the account owner may enter payment account data into a portable communication device, personal computer, or other device capable of communicating with a merchant computer. In a further example, communication may occur between a contactless element of a portable communication device and an access device, such as a merchant device reader or point of sale terminal, by using a wireless communications mechanism, such as near field communications (NFC), RF, infra-red, optical communications, etc.

An “access device” may be any suitable device that provides access to a remote system. An access device may also be used for communicating with a merchant computer, a transaction processing computer, an authentication computer, or any other suitable system.

An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some aspects, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some aspects, a cellular phone, tablet, or other dedicated wireless device used as a POS terminal may be referred to as a mobile point of sale or an “mPOS” terminal.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

A “user device” is an electronic device that may be transported and/or operated by a user. A user device may provide remote communication capabilities to a network. The user device may be configured to transmit and receive data or communications to and from other devices. In some aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, notebooks, netbooks, ultrabooks, etc.). Examples of user devices may also include automobiles with remote communication capabilities.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. An “application” may be computer code or other data stored on a computer readable medium (e.g. memory element or secure element) that may be executable by a processor to complete a task.

The terms “point-of-sale system,” “POS system,” “POS terminal,” “point-of-purchase system,” “POP system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like).

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—e.g., using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUls) with which a user may interact, either directly or indirectly (e.g., through a keyboard, mouse, touchscreen, etc.).

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an aspect, but other elements may be added and still form a construct within the scope of a claim. In contrast, the transitional phrase “consisting of” excludes any element, step, or ingredient not specified in a claim. This is consistent with the use of the term throughout the specification.

As used herein, an “electronic wallet” or “digital wallet” or “mobile wallet” can store user profile information, payment information (including tokens), bank account information, and/or the like and can be used in a variety of transactions, such as but not limited to e-commerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device.

As used herein, the term “electronic wallet provider” may include an entity that provides and/or maintains an electronic wallet and/or an electronic wallet mobile application for a user (e.g., a customer). Examples of an electronic wallet provider include, but are not limited to, Google Wallet™, Android Pay@, Apple Pay@, and Samsung Pay@, and/or other like electronic payment systems. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

A “digital wallet provider” may include an entity, such as an issuing bank or third party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

As used herein, “identification information” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors).

As used herein, an “online purchase” can be the purchase of a digital or physical item or service via a network, such as the Internet.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” can typically be a business entity (e.g., a commercial bank) that has a business relationship with a particular merchant or other entity. Some entities can perform both issuer and acquirer functions. Some aspects may encompass such single entity issuer-acquirers. An acquirer may operate an acquirer computer, which can also be generically referred to as a “transport computer”.

As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting aspects, an acquirer may be a financial institution, such as a bank.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

An “alias directory” may represent a payment processing network alias merchant directory that maps an alias merchant to a dynamic transaction code. A payment processing network client can use the alias directory to allow consumers to initiate push payments using an alias. The payment processing network client first provides the alias directory with an alias and receives the dynamic transaction code mapped to that alias, which can then be used in a push payment.

As used herein a “transaction code computer” is an interface between a merchant computer and an alias directory. The transaction code computer includes a transaction code engine to generate a dynamic transaction code at the request of the merchant computer. The transaction code computer tracks an d updates the dynamic transaction code in real-time.

A “transaction code engine” is used to generate a dynamic transaction code. The transaction code engine generates a dynamic transaction codes for presentation through a website and or through any suitable transaction code generator extensions.

In one aspect, the present disclosure is directed to a payment system and method that integrates with transaction code payments on a merchant's online website to enable users to scan the transaction code and pay without having to store any personal information of the payment platform. In one aspect, a transaction code payment system and method according to the present disclosure employs an alias directory and a payment method generating the transaction code, for example. In one aspect, a transaction code may be a QR code or any type of matrix barcodes (or two-dimensional barcodes).

In one general aspect, the present disclosure describes the interaction of a payment method alias directory and transaction code generator to preserve merchant/consumer sensitive data. In one general aspect, an alias directory and a transaction code engine enable merchants to create and employ dynamic transaction codes without disclosing/receiving sensitive data. The transaction codes are conveyed to a consumer whose application interacts with the alias directory to access/validate the merchant's details needed to complete a payment transaction through the consumer's application back end server.

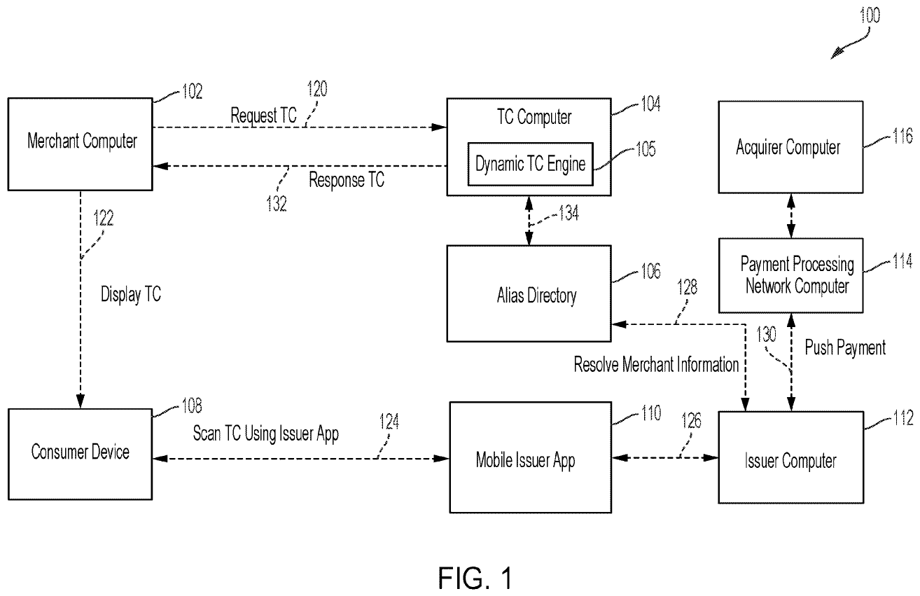

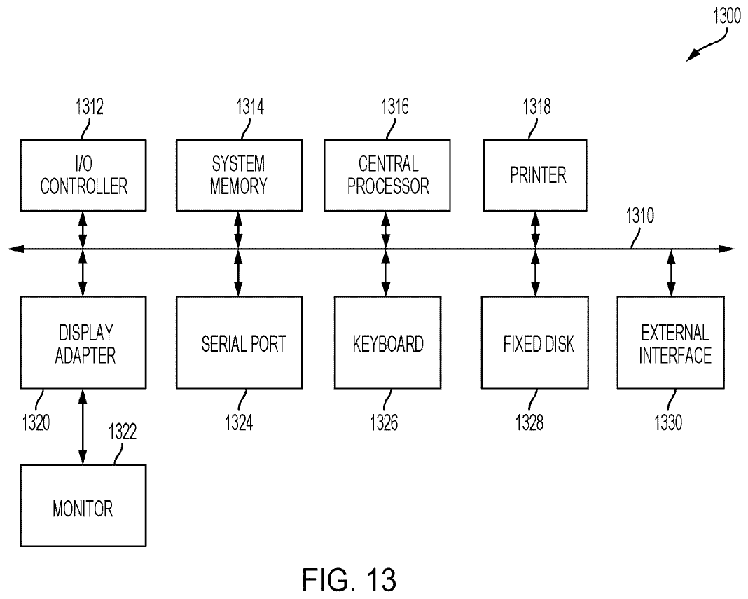

FIG. 1 illustrates a transaction code account based payment system 100, according to at least one aspect of the present disclosure. The transaction code account based payment system 100 comprises a merchant computer 102, a transaction code computer 104 (e.g., QR code computer) comprising a dynamic transaction code engine 105 (e.g., QR engine), an alias directory 106, a consumer device 108 running a mobile app 110 provided by an issuer, an issuer computer 112, a payment processing network computer 114, and an acquirer computer 116. Any of the computers 102, 104, 112, 112, 116 may be implemented as servers. In some aspects, different entities illustrated in FIG. 1 may communicate with each other using one or more communication networks such as the Internet, a cellular network, a TCP/IP network, or any other suitable communication network. Note that one or more entities in the transaction code account based payment system 100 may be associated with a computer apparatus that may be implemented using some of the components as described with reference to FIG. 13, for example. The consumer may utilize the consumer device 108 to initiate a transaction with a merchant computer 102 by interacting with an access device, e.g., a point-of-sale (POS) device, point-of-purchase (POP) device, or any suitable access device.

In some aspects, the consumer device 108 may be a payment device, a user device, a mobile device such as a mobile phone, a tablet, a personal digital assistant (PDA), a notebook computer, a key fob, or any suitable mobile device. For example, the consumer device 108 may include a wallet or a payment application that may be associated with one or more payment accounts of the consumer. In some aspects, the consumer device 108 may be configured to display a machine readable code transaction code (e.g., QR code, bar code, etc.). The consumer device 108 also may include a camera or a scanning device capable of scanning a machine readable transaction code. In some aspects, the consumer device 108 may be capable of communicating with other devices using a short range communication technology such as near field communication (NFC). For example, the consumer device 108 may interact with an access device by tapping or waving the consumer device 108 in proximity of the access device or through various wireless techniques.

In one aspect, the access device may be an access point to a transaction processing system that may comprise the acquirer computer 116, the payment processing network computer 114, and the issuer computer 112. In some aspects, the access device may be associated with or operated by the merchant computer 102. For example, the access device may be a POS or POP device that may include a contactless reader, an electronic cash register, a display device, etc. In some aspects, the access device may be configured to display transaction information in a format that may be read by the consumer device 108 (e.g., mobile phone) including a machine readable transaction code such as a QR code, bar code, or any other information transfer mechanism. In some aspects, the access device may be a personal computer that may be used by the consumer to initiate a transaction with the merchant computer 102 (e.g., an online transaction).

The merchant computer 102 may be associated with a merchant. In some aspects, the merchant computer 102 may be associated with a card-on-file (COF) merchant. For example, the card-on-file merchant may store consumer account information on file (e.g., at a merchant database) for future payment purposes such as various types of periodic payments (e.g., monthly utilities payments). In some aspects, a consumer may register with one or more merchants for COF services. The merchant computer 102 may be configured to generate an authorization request for a transaction initiated by the consumer using the access device. The merchant computer 102 may be configured to request a machine readable transaction code upon detecting a shopping cart checkout and receive and display the machine readable transaction code on the access device. In various aspects, the machine readable transaction code is a dynamic transaction code, such as, for example, a dynamic QR code, although the present disclosure is not limited in this context.

The acquirer computer 116 may represent a traditional acquirer/acquirer processor. The acquirer is typically a system for an entity (e.g., a bank) that has a business relationship with a particular merchant, a wallet provider, or another entity. The acquirer computer 116 may be communicatively coupled to the merchant computer 102 and the payment processing network computer 114 and may issue and manage a financial account for the merchant. The acquirer computer 116 may be configured to route the authorization request for a transaction to the issuer computer 112 via the payment processing network computer 114 and route an authorization response received via the payment processing network computer 114 to the merchant computer 102.

The payment processing network computer 114 may be configured to provide authorization services, and clearing and settlement services for payment transactions. The payment processing network computer 114 may include data processing subsystems, wired or wireless networks, including the Internet. An example of a payment processing network includes VisaNet™, operated by Visa®. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. The payment processing network may include a computer, such as the payment processing network computer 114. In some aspects, the payment processing network computer 114 may forward an authorization request received from the acquirer computer 116 to the issuer computer 112 via a communication channel. The payment processing network computer 114 further may forward an authorization response message received from the issuer computer 112 to the acquirer computer 116.

The issuer computer 112 may represent an account issuer and/or an issuer processor. Typically, the issuer computer 112 may be associated with a business entity (e.g., a bank) that may have issued an account and/or payment card (e.g., credit account, debit account, etc.) for payment transactions. In some aspects, the business entity (bank) associated with the issuer computer 112 also may function as an acquirer (e.g., the acquirer computer 116).

The transaction code computer 104 is an interface between the merchant computer 102 and the alias directory 106. The transaction code computer 104 includes a dynamic transaction code engine 105 to generate a dynamic transaction code at the request of the merchant computer 102, for example. The transaction code computer 104 tracks and updates the dynamic transaction code in real-time. The dynamic transaction code engine 105 generates a dynamic transaction codes for presentation through a website or through any suitable transaction code generator extensions. Examples of transaction codes include QR codes Models 1 and 2, bar codes, matrix barcodes, two-dimensional barcodes, micro QR codes, iQR codes, SQRC codes, frameQR codes, High Capacity Colored 2-Dimensional (HCC2D) codes, or any other information transfer mechanism. It will be appreciated that QR code Model 1 is the original QR code where the largest version of this code is 14 (73×73 modules), which is capable of storing up to 1,167 numerals. QR code Model 2 is an improvement on Model 1 with the largest version being 40 (177×177 modules), which is capable of storing up to 7,089 numerals. In various aspects, the transaction code computer 104 may be configured to receive a request 120 for a dynamic transaction code from the merchant computer 102 where the request 120 includes a merchant alias identifier. In various aspects, the transaction code computer 104 may be configured to query an alias directory 106 that stores merchant information details used to validate 134 the merchant with the alias directory 106 based on the merchant alias identifier provided in the request 120 for the dynamic transaction code. In various aspects, the transaction code computer 104 includes a transaction code engine 105 to generate the dynamic transaction code after validating the merchant with the alias directory 106 based on the merchant alias identifier. In various aspects, the transaction code computer 104 may be configured to transmit a response to the merchant computer 102 request for the dynamic transaction code.

The alias directory 106 may represent a payment processing network alias merchant directory. The alias directory 106 service maps an alias merchant to a dynamic transaction code. A payment processing network client can use the alias directory 106 to allow consumers to initiate push payments using an alias. The payment processing network client first provides the alias directory 106 with an alias and receives the dynamic transaction code mapped to that alias, which can then be used in a push payment. In various aspects, the alias directory 106 stores merchant information details that can be validated based on the merchant alias identifier provided in the request for a dynamic transaction code.

In various aspects, as a precondition to register the merchant on the alias directory 106, the merchant computer 102 onboards or stores merchant information details to the alias directory 106. Onboarding the merchant information details in the alias directory 106 includes receiving, by the alias directory 106, a merchant payment option selection from the merchant computer 102, inserting, in the alias directory 106, account information related to the selected merchant payment option, and inserting, in the alias directory 106, merchant identification information. Additional merchant information details may be onboarded to the alias directory 106.

In a transaction process, the merchant computer 102 requests 120 a dynamic transaction code from the transaction code computer 104. The request 120 includes at least a merchant alias identifier. In other aspects, the request 120 may additionally include at least one of a transaction currency information or transaction amount information. The transaction code computer 104 is communicatively coupled to the alias directory 106. After receiving the request for the dynamic transaction code from the merchant computer 102, the transaction code computer 104 queries the alias directory 106 storing the merchant information details.

The transaction code computer 104 validates the merchant with the alias directory 106 based on the merchant alias identifier transmitted with the request for a dynamic transaction code. After validating the merchant, a dynamic transaction code engine 105 generates the dynamic transaction code and the transaction code computer 104 transmits a response 132 to the merchant computer 102 responsive to the request 120 for the dynamic transaction code. In various aspects, the response may include at least one of a dynamic transaction code identifier, a dynamic transaction code universal resource locator (URL), or an expiry code.

After receiving the dynamic transaction code, the merchant computer 102 displays 122 the dynamic transaction code on an access device, such as, for example, a merchant e-commerce website or merchant POS/POP device. Once the merchant computer 102 displays the dynamic transaction code, the consumer scans 124 the dynamic transaction code with the consumer device 108 running the mobile app 110. Once the dynamic transaction code is scanned, the mobile app 110 communicates 126 the scanned dynamic transaction code data to the issuer computer 112. After receiving the scanned dynamic transaction code data, the issuer computer 112 resolves 128 the merchant information stored in the alias directory 106. After resolving 128 the merchant information, the issuer computer 112 pushes 130 payment to the acquirer computer 116 via the payment processing network computer 114.

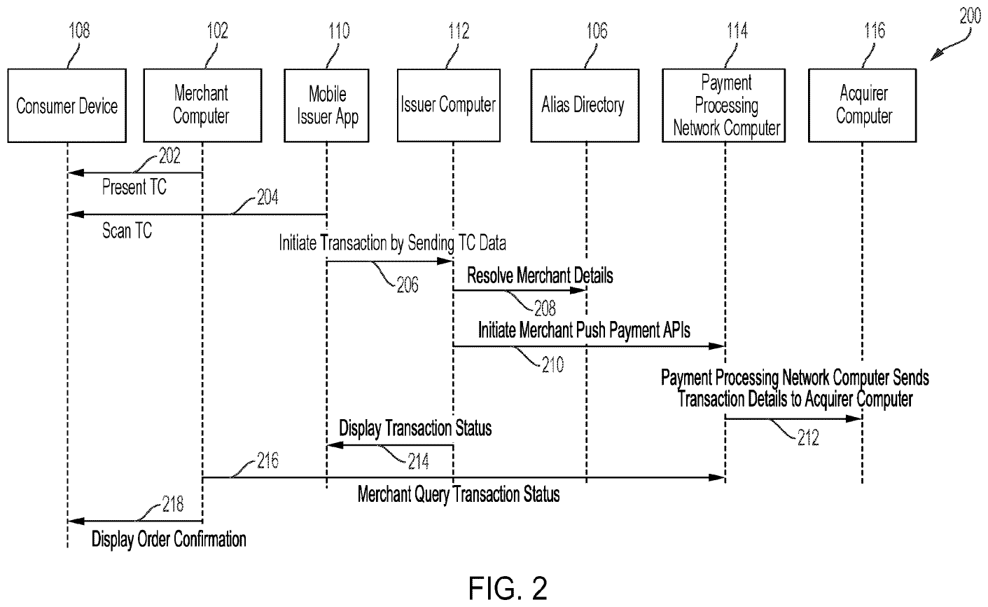

FIG. 2 is a swimlane flow diagram 200 of a transaction executed on the transaction code account based payment system 100 shown in FIG. 1, according to at least one aspect of the present disclosure. The merchant computer 102 presents 202 a dynamic transaction code, such as a dynamic QR code, for example, to the consumer device 108. The consumer scans 204 the dynamic transaction code using the mobile app 110 running on the consumer device 108. After scanning the dynamic transaction code, the mobile app 110 initiates 206 a transaction by sending the dynamic transaction code data to the issuer computer 112. The issuer computer 112 resolves 208 the merchant details stored in the alias directory 106 and initiates 210 merchant push payments application programming interfaces (APIs) with the payment processing network computer 114. The payment processing network computer 114 then sends 212 transaction details to the acquirer computer 116. The issuer computer 112 displays 214 the transaction status on the mobile app 110. The merchant computer 102 queries 216 the transaction status via the payment processing network computer 114.

Finally, the merchant computer 102 displays 218 the order confirmation on the consumer device 108.

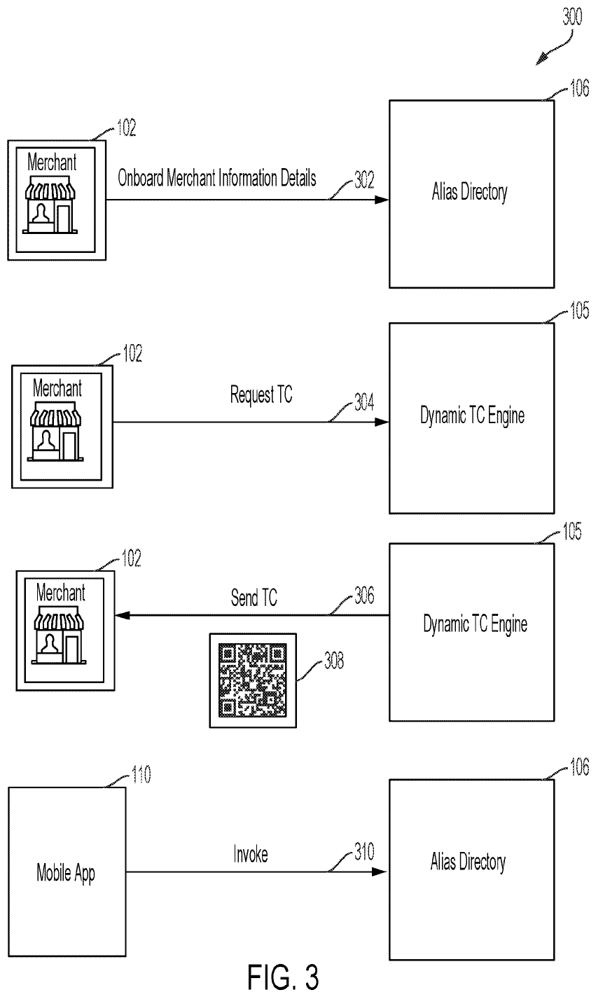

FIG. 3 is a flow diagram 300 of several stages of a transaction executed on the transaction code account based payment system 100 shown in FIG. 1, according to at least one aspect of the present disclosure. During an initialization procedure, the merchant computer 102 onboards 302 the merchant information to the alias directory 106. The onboarding 302 process entails the onboarding 302 by the merchant the merchant information details to the alias directory 106 and establishing a merchant alias identifier. During the onboarding process, the alias directory 106 captures the merchant information details such as, for example, merchant payments options, account information related to a selected payment option, and/or merchant identification information from the merchant computer 102. The alias directory 106 selects the merchant payment options and inserts account information related to the selected payment options. Account information may include, for example, a personal account number (PAN), account number, digital wallet identification, crypto account number, among other account information related to the selected payment option. The alias directory 106 then inserts the merchant identification information such as, for example, merchant payment processing network identification, merchant phone number, merchant email, among other merchant identification information.

During a payment transaction, the merchant computer 102 requests 304 a dynamic transaction code 308 from the transaction code computer 104. For example, the merchant computer 102 may request 304 a dynamic QR code or similar transaction code from the transaction code computer 104 to display on an access device such as an online shopping cart checkout page or merchant POS/POP terminal, for example. The request 304 follows standard authentication and authorization mechanisms such as single sign-in service to pay for online purchases or unified digital payments service. In one aspect, the request 304 parameter structure may include an endpoint and a request body. The endpoint portion includes the payment processing network Hypertext Transfer Protocol Secure (HTTPS) where the dynamic transaction code is created and the request body includes merchant alias identifier, transaction currency, and purchase amount, among other request parameters. This technique is scalable to small and midsize business spaces, builds on the acceptance of dynamic transaction codes, such as dynamic QR transaction codes, for example, and avoids static QR code transaction displays.

In one aspect, the form of the request 304 from the merchant computer 102 to the transaction code computer 104/dynamic transaction code engine 105 may be defined according to the following Endpoint and Request Body structures:

### Endpoint

https://{payment_processing_network_qr}/createqr

Request Body

```
{
  merchantAlias: 84939433
  transactionCurrencyCode: 345
  amount: 23.04
}
```

Where “merchantAlias” is the merchant alias identifier, “transactionCurrencyCode” represents the transaction currency, and “amount” is the transaction amount.

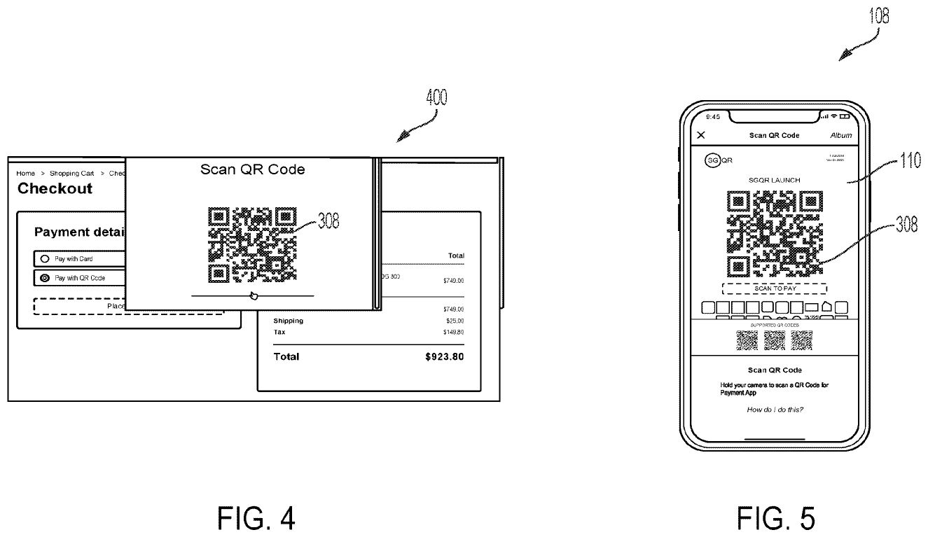

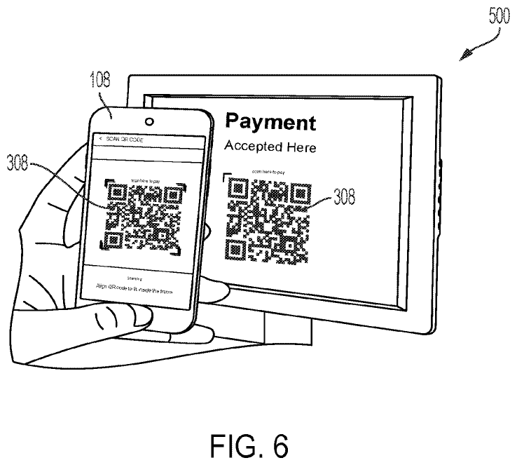

After receiving the request 304 from the merchant computer 1012, and after validating the merchant, the transaction code computer 104 sends 306 the dynamic transaction code 308 to the merchant computer 102. The response body includes, for example, the dynamic transaction code identification number, the universal resource locator for the transaction code image, and the expiry information, among other response body parameters. No sensitive data, such as a PAN, is transmitted between merchant and consumer. The consumer account data is stored in the consumer device 108, but not transmitted to the merchant computer 102. The dynamic transaction code 308, here shown as a dynamic QR code, for example, is then displayed on the merchant website 400, as shown in FIG. 4, the mobile app 110 running on the consumer device 108 as shown in FIG. 5, or the merchant POS/POP terminal 500 as shown in FIG. 6. The consumer then scans the dynamic transaction code using the mobile app 110 executing on the consumer device 108.

In one aspect, the form of the response may be defined according to the following Response Body structure:

Response Body

```
{
  qrId: 3049493003930404
  qrlmageUrl: “http://
  {payment_processing_network_qr}/004040394404.png”
  expiryTs: 621310ee
}
```

Where “qrld” is the unique identifier of the dynamic transaction code, “qrlmageUrl” is the address of the unique dynamic transaction code on the payment processing network website, and “expiryTs” is the HEX epoch value to expire the dynamic transaction code.

Returning now to FIG. 3, after the dynamic transaction code 308 is scanned, the mobile app 110 invokes 310 the alias directory 106 to resolve the merchant payment instrument. For example, the mobile app 110 communicates to the alias directory 106 to access the merchant bank information, such as, for example, the merchant bank account, payment options, and routing, which is returned to the mobile app 110. This process is kept separate for security purposes. The endpoint parameters for invoking 310 the alias directory 106 include the merchant identifier and the payment processing network payment option, among other information. The response parameters include the encrypted payment instrument, for example. Once the mobile app 110 receives the merchant information details the payment processing network software completes the payment transaction in standard business as usual (BAU) payment flows using the provided merchant account information details. Final transactions occur through established payment channels and integrations.

In one aspect, the form of invocation message from the mobile app 110 to the alias directory 106 may be defined according to the following Endpoint and Response structures:

Endpoint

```
https://{payment_processing_network_alias}/resolve
{
  merchantId: 84939433
  paymentOption: PAYMENT PROCESSING NETWORK (VISA, MC,
  ETH)
}
```

Response

```
{
  paymentInstrument: encrypted
  merchantDetails: {
  merchantCategoryCode: “3444”,
  “address”: {
  “country”: “IN”,
  “city”: “KOLKATA”
  }
  }
}
```

In various aspects, an encrypted payment instrument will carry all necessary payment account details and merchant details such as a merchant category code and address details to satisfy transaction request parameters. For example,

P2A

```
“bank”: {
  “branchCode″: “2″,
  ″bankCode″: ″021001088″,
  ″bankCodeType″: ″ABA″,
  ″accountNumberType″: ″DEFAULT″,
  ″accountName″: ″account name″,
  ″countryCode″: ″840″,
  ″accountType″: ″1″,
  ″bankName″: ″Bank of America″,
  ″accountNumber″: ″4385878xxxxxxx″,
  ″BIC″: ″CTBAAU2S″,
  ″currencyCode″: ″840″
},
```

### P2C

“primaryAccountNumber”: “49570304xxxxxx”

### CRYPTO

“cryptoWalletAddress” and other required details.

The data stored in the dynamic transaction code 308, may include for example, website URLs, phone numbers, or up to a predetermined number of characters of text. The dynamic transaction codes also can be used to link directly to download an app on an app store, authenticate online accounts, and verify login details.

In one aspect, the form of the dynamic transaction code 308 may be defined according to the following Dynamic Transaction Code structure, which is further defined in TABLES 1-3.

Dynamic Transaction Code

```
{
  qrId: 3049493003930404
  merchantAlias: 84939433
  aliasType: VMID
  amount: 124.05
  transactionCurrencyCode: 356
  paymentOption: P2C, P2A, etc...
  expiryTs: 621310ee
}
```

In one example, a dynamic transaction code 308 in accordance with the present disclosure may include the information shown in TABLE 1.

TABLE 1

| Field | DataType | Description |
|---|---|---|
| qrId | String | Unique QR identifier |
| merchantAlias | String | This field carries value to |
| | | identify the merchant, it can |
| | | be merchant email, phone |
| | | number or merchant id etc . . . |
| | | Type of the merchant alias |
| | | will be indicated by the alias |
| | | Type field |
| aliasType | String | Merchant Visa ID (VMID) |
| | | Merchant Mastercard ID |
| | | (MMID) |
| | | Email (EMAIL) |
| | | Phone Number (MOBIL) |
| | | Other forms of ID types: ID |
| | | forms of other banks, crypto |
| | | networks and FinTech's |
| | | which provides desired |
| | | payment instruments for the |
| | | merchant |
| amount | String | Transaction Amount |
| transactionCurrencyCode | String | Transaction Currency Code |
| paymentOption | String | Desired payment option for |
| | | that merchant |
| | | Pay to Card (P2C) |
| | | Pay to Account (P2A) |
| | | Pay to CryptoAccount |
| | | (P2CRYPTO) |
| | | Other payment options (ex |
| | | pay to wallet) |
| expiryTs | String | HEX epoch value to expire |
| | | QR code |
| | | See Website: |
| | | epochconverter.com/clock |

In accordance with one aspect of the present disclosure, TABLE 2 shows the AliasType codes.

TABLE 2

| | |
|---|---|
| Visa Merchant ID | VMID |
| Master Card Merchant ID | MMID |
| AMEX merchant ID | AMID |
| Email | EMAIL |
| Phone No | MOBIL |

In accordance with one aspect of the present disclosure, TABLE 3 shows the PaymentOptions codes.

TABLE 3

| | |
|---|---|
| P2C | Pay to card Visa, Mastercard, Amex, etc . . . |
| | (upon receiving the payment instrument |
| | routing endpoint can derive from the BON |
| | pattern) |
| P2A | Pay to bank account (payment instrument |
| | in this case will return necessary bank |
| | account details swift code, account number, |
| | name, BSB, etc . . . |
| P2CRYPTO | Crypto wallet ID |

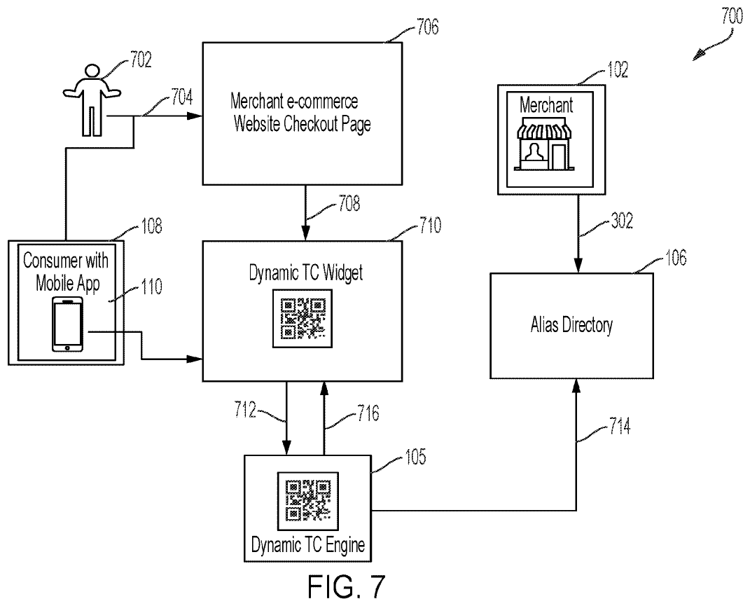

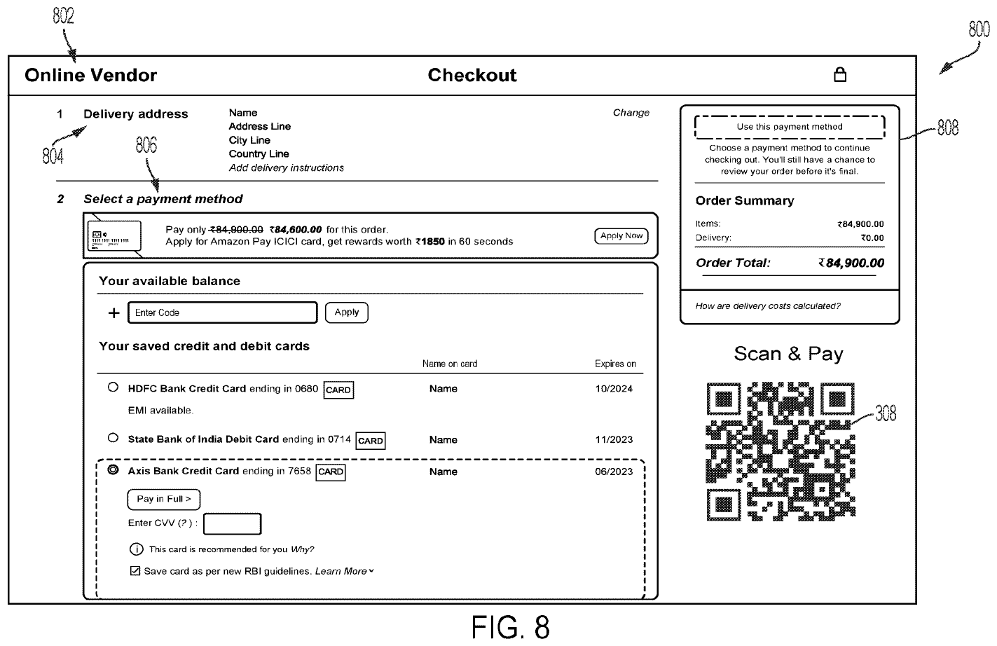

FIG. 7 is a flow diagram 700 of a consumer completing a transaction with a merchant, according to at least one aspect of the present disclosure. A consumer 702 selects 704 to checkout the shopping cart on a merchant e-commerce website checkout page 706. An example of a merchant e-commerce website checkout page 800 is shown in FIG. 8. With reference back to FIG. 7, the merchant e-commerce website checkout page 706 initializes 708 a dynamic transaction code widget 710, which sends 712 the merchant information and shopping cart value to the dynamic transaction code engine 105 to generate a dynamic transaction code for the consumer selected transaction. The merchant information and shopping cart value may include, for example, merchant identifier, fee, and currency, among other parameters. The dynamic transaction code engine 105 validates 716 the merchant identifier with the alias directory 106 using a merchant lookup API. As previously discussed, as a pre-condition to registering the merchant to the alias directory, the merchant computer 102 onboards 302 the merchant information details to the alias directory 106. The alias directory 106 captures the merchant information details such as merchant identifier, PAN details, payment options (card or account), among other merchant information details. The dynamic transaction code engine 105 generates the dynamic transaction code 308 and sends 712 the dynamic transaction code 308 back to the dynamic transaction code widget 710.

The dynamic transaction code widget 710 places the dynamic transaction code 308 on the access device display screen. After the dynamic transaction code widget 710 displays the dynamic transaction code 308, the consumer 702 scans the dynamic transaction code 308 using the mobile app 110 running on the consumer device 108 and completes the payment transaction in standard BAU payment flows through established payment channels and integrations using the provided merchant account information details. The mobile app 110 looks up the merchant identifier and retrieves the payment options. The mobile app 110 may be configured to support card-to-account and account-to-account payment options using the payment processing network payout APIs. A payment processing network payout API is a secure and fast way to pay and be paid using consumer devices 108 and enables a range of payment use cases. The API is technology agnostic and leverages evolving POS/POP environments such as dynamic transaction codes 308 and works on consumer devices 108 such as smart phones or feature phones, for example, among other mobile devices.

FIG. 8 is a screen shot of a merchant e-commerce website checkout page 800, according to at least one aspect of the present disclosure. The merchant e-commerce website checkout page 800 includes information such as the online vendor 802, delivery address section 804, a select payment method 806, an order summary and total section 808, and a dynamic transaction code 308, generated and displayed on the merchant e-commerce website checkout page 800 as previously described. Once the dynamic transaction code 308 is displayed on the merchant e-commerce website checkout page 800, the consumer can scan the dynamic transaction code 308 and complete the payment transaction.

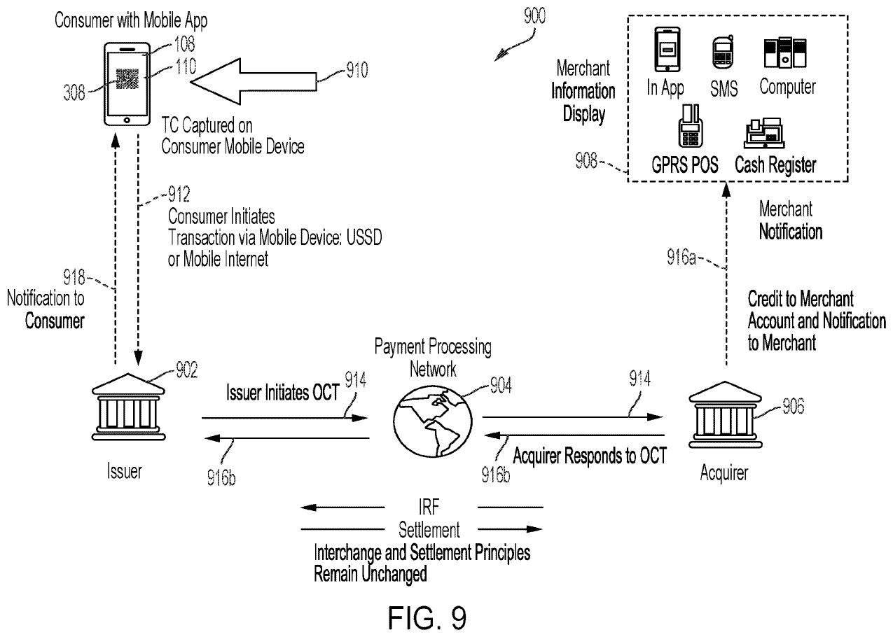

FIG. 9 illustrates a mobile app payment flow diagram 900, according to at least one aspect of the present disclosure. The consumer device 108 captures 910 the dynamic transaction code 308 using the mobile app 110 running on the consumer device 108. The consumer initiates 912 the transaction via the consumer device 108 over unstructured supplementary service data (USSD) or mobile Internet to the issuer 902. The issuer 902 initiates 914 an original credit transaction (OCT) with the acquirer 906 via the payment processing network 904. The acquirer 906 credits 916a the merchant account and notifies the merchant via the merchant access device 908. The acquirer 906 responds 914b to the OCT to the issuer 902 via the payment processing network 904. The issuer 902 then notifies 918 the consumer to complete the transaction.

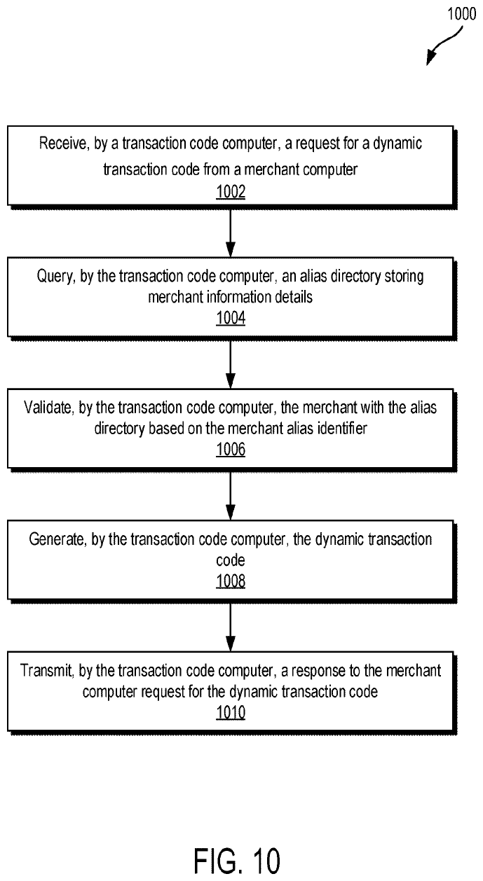

FIG. 10 is a logic flow diagram of a method 1000 of anonymously conducting a secured payment transaction between a consumer and a merchant, according to at least one aspect of the present disclosure. With reference also to FIG. 1, the method 1000 is carried out at a transaction code computer 104 in communication with an alias directory 106. According to the method 1000, the transaction code computer 104 receives 1002 a request 120 for a dynamic transaction code from a merchant computer 102. The request 120 includes a merchant alias identifier. The transaction code computer 104 queries 1004 an alias directory 106 storing merchant information details. The transaction code computer 104 validates 1006 the merchant with the alias directory 106 based on the merchant alias identifier. The transaction code computer 104 generates 1008 the dynamic transaction code. The transaction code computer 104 transmits 1010 a response 132 to the merchant computer 102 request 120 for the dynamic transaction code. In one aspect of the method 1000, the dynamic transaction code is a dynamic quick response (QR) code.

In one aspect of the method 1000, the request 120 may include transaction currency information. In another aspect of the method 1000, the request 120 may include transaction amount information.

In one aspect of the method 1000, the response 132 may include a dynamic transaction code identifier. In another aspect of the method 1000, the response 132 may include a universal resource locator (URL) for the dynamic transaction code. In yet another aspect of the method 1000, the response 132 may include an expiry code for the dynamic transaction code.

In one aspect, the method 1000 further includes onboarding, by the merchant computer 102, the merchant information details to the alias directory 106. In another aspect of the method 1000, onboarding the merchant information details in the alias directory 106 includes the alias directory 106 receiving a merchant payment option selection from the merchant computer 102, inserting, in the alias directory 106, account information related to the selected merchant payment option, and inserting, in the alias directory 106, merchant identification information.

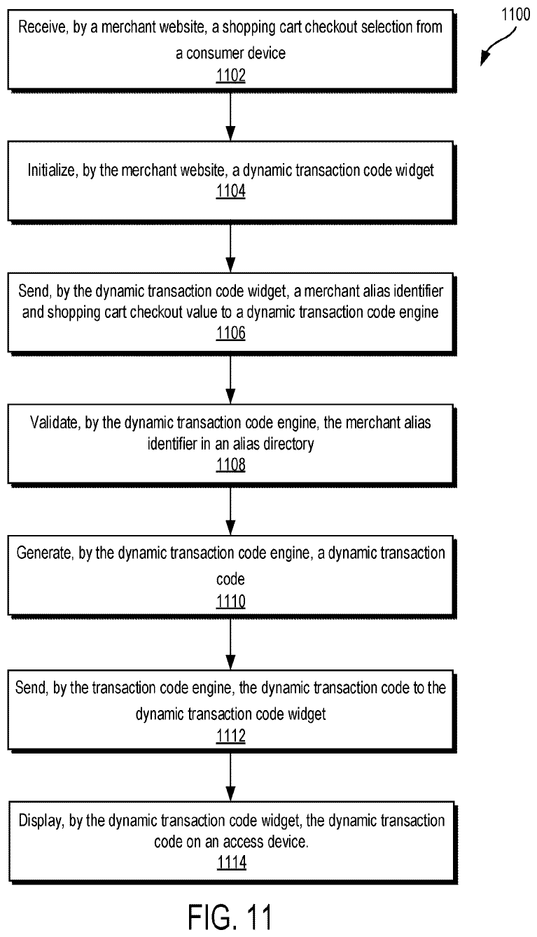

FIG. 11 is a logic flow diagram of a method 1100 of anonymously conducting a secured payment transaction between a consumer and a merchant, according to at least one aspect of the present disclosure. With reference also to FIGS. 7 and 8, according to the method 1100, a merchant e-commerce website checkout page 706 receives 1102 a shopping cart checkout selection 704 from a consumer 702 using a consumer device 108. The merchant e-commerce website checkout page 706 initializes 1104 a dynamic transaction code widget 710. The dynamic transaction code widget 710 sends 1106 a merchant alias identifier and shopping cart checkout value to a dynamic transaction code engine 105. The dynamic transaction code engine 105 validates 1108 the merchant alias identifier in an alias directory 106. The dynamic transaction code engine 105 generates 1110 a dynamic transaction code 308. The dynamic transaction code engine 105 sends 1112 the dynamic transaction code 308 to the dynamic transaction code widget 710. The dynamic transaction code widget 710 displays the dynamic transaction code 308 on an access device. N one aspect of the method 1100, the dynamic transaction code 308 is a dynamic quick response (QR) code.

In one aspect of the method 1100, a consumer device 108 scans the dynamic transaction code 308 displayed on the access device with a consumer device 108 executing an mobile app 110. In another aspect of the method 1100, the consumer device 108 performs payment based on the dynamic transaction code.

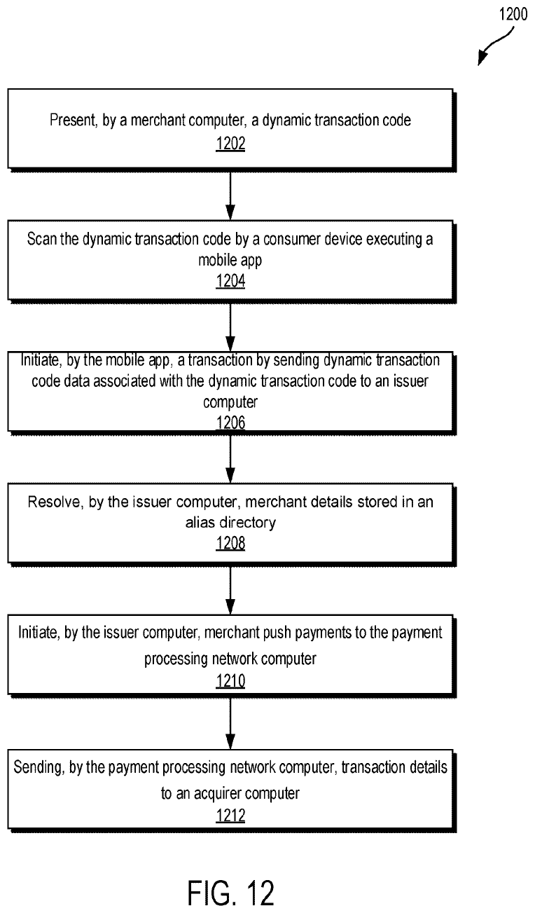

FIG. 12 is a logic flow diagram of a method 1200 of anonymously conducting a secured payment transaction between a consumer and a merchant, according to at least one aspect of the present disclosure. With reference also to FIGS. 1-9, according to the method 1200, a merchant computer 102 presents 1202 a dynamic transaction code 308. A consumer device 108 executing a mobile app 110 scans 1204 the dynamic transaction code 308. The mobile app 110 initiates 1206 a transaction by sending dynamic transaction code data associated with the dynamic transaction code 308 to an issuer computer 112. The issuer computer 112 resolves 1208 merchant details stored in an alias directory 106. The issuer computer 112 initiates 1210 merchant push 130 payments to the payment processing network computer 114. The payment processing network computer 114 sends 1212 transaction details to an acquirer computer 116.

In one aspect of the method 1200, the issuer computer 112 displays transaction status on the mobile app 110. In another aspect of the method 1200, the merchant computer 102 queries the transaction status via the payment processing network computer 114. In another aspect of the method 1200, the merchant computer 102 displays order confirmation on the consumer device 108.

In one aspect of the method 1200, the dynamic transaction code is a dynamic quick response (QR) code. In another aspect of the method 1200, the dynamic QR code comprises at least a unique dynamic QR code identifier and a merchant alias identifier. In yet another aspect of the method 1200, the dynamic QR code also includes at least a merchant alias type, a transaction amount, a transaction currency code, a payment option, and an expiry code for the dynamic QR code.

FIG. 13 is a block diagram of a computer apparatus 1300 with data processing subsystems or components. The subsystems shown in FIG. 13 are interconnected via a system bus 1310. Additional subsystems such as a printer 1318, keyboard 1326, fixed disk 1328 (or other memory comprising computer readable media), monitor 1322, which is coupled to display adapter 1320, and others are shown. Peripherals and input/output (I/O) devices, which couple to I/O controller 1312 (which can be a processor or other suitable controller), can be connected to the computer system by any number of means known in the art, such as serial port 1324. For example, serial port 1324 or external interface 1330 can be used to connect the computer apparatus to a wide area network such as the Internet, a mouse input device, or a scanner. The interconnection via system bus allows the central processor 1316 to communicate with each subsystem and to control the execution of instructions from system memory 1314 or the fixed disk 1328, as well as the exchange of information between subsystems. The system memory 1314 and/or the fixed disk 1328 may embody a computer readable medium.

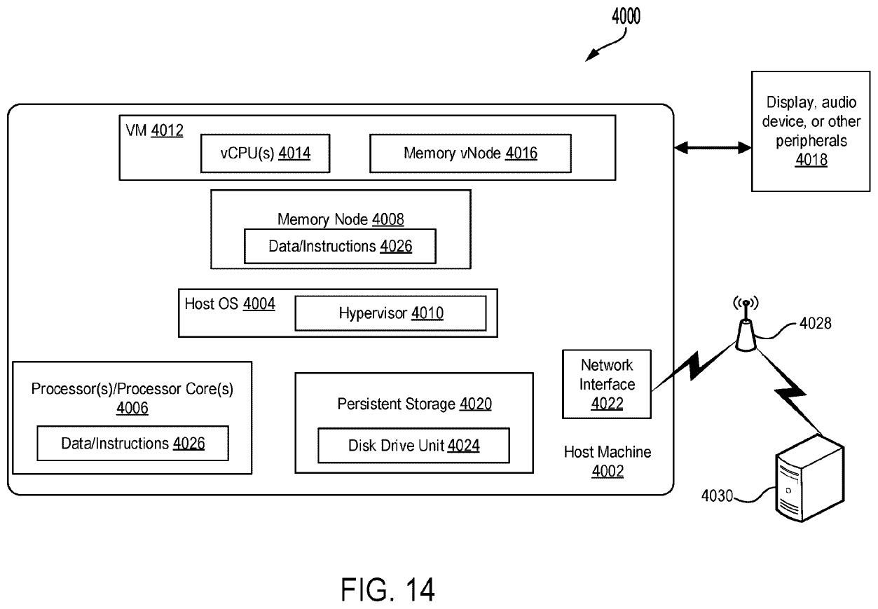

FIG. 14 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the example system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM.

Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The significant increase in mobile payments over the past few years (500%+) creates many new opportunities for payment transaction options such as the dynamic transaction codes coupled with a validation of merchant alias as described herein. This technique provides one of the fastest checkout methods without the use of a payment card. Dynamic transaction code payments will boost merchant revenue and lead to increased revenue for payment processors.

Over 90% of the merchants who trade online use shopping carts. Accordingly, payment processors can integrate the dynamic transaction code payment techniques on shopping carts like Magento, WooCommerce, Shopify, BigCommerce, etc. and provide incentives to adopt the integration solution. As users are already accustomed to QR payments they can simply scan and checkout without having to wait for a one time password (OTP), two-factor authorization (2FA), or three domain security (3DS) protocol, each of which will increase the conversion rate and decrease the drop rate.

In employing dynamic transaction code payments, merchant will not have to worry about payment card industry compliance as card details are not entered on the website and the transaction is processed securely through QR tokens.

The above aspects of the dynamic transaction code payments system provides several advantages. First, payment card details are not shared with the merchant. The process is highly secure and avoids payment card industry data security standard processes for merchants. In addition, there is no dependency on mobile carrier for OTP. The dynamic online transaction code improves overall payments experience from 120 sec to 15 sec and bypasses OTP, 2FA and 3DS security flows. The dynamic online transaction code is easily integrated and provides higher conversion. Additional benefits include demonetization, social distancing, convenience/hassle free/cashless, familiarity in that consumers have become accustomed to QR payments. Further, the dynamic online transaction code payments can be implemented on existing infrastructure using existing payment processor software development kits and APIs and provides a simplified checkout method that is secure.

To the consumers, additional benefits include not having to store payment card details on any merchant site, re-using existing bank unified payment interface (UPI) apps, and trust as consumers have already accustomed to QR payments in local shops. The dynamic online transaction code payment system and methods described herein provide the fastest checkout method without entering and storing any payment card details on a merchant website. Consumers can re-use already installed bank apps to process the payment.

Examples of the devices, systems, and methods disclosed herein, according to various aspects of the present disclosure, are provided below in the following numbered clauses. An aspect of the devices, systems, and methods may include any one or more than one, and any combination of, the numbered clauses described below.

Clause 1. A method of anonymously conducting a secured payment transaction between a consumer and a merchant, the method carried out at a transaction code computer in communication with an alias directory, the method comprising: receiving, by a transaction code computer, a request for a dynamic transaction code from a merchant computer, wherein the request comprises a merchant alias identifier; querying, by the transaction code computer, an alias directory storing merchant information details; validating, by the transaction code computer, the merchant with the alias directory based on the merchant alias identifier; generating, by the transaction code computer, the dynamic transaction code; and transmitting, by the transaction code computer, a response to the request for the dynamic transaction code to the merchant computer.

Clause 2. The method of clause 1, wherein the request comprises transaction currency information.

Clause 3. The method of clause 2, wherein the request comprises transaction amount information.

Clause 4. The method of any one of clauses 1-3, wherein the response comprises a dynamic transaction code identifier.

Clause 5. The method of clause 4, wherein the response comprises a universal resource locator (URL) for the dynamic transaction code.

Clause 6. The method of clause 5, wherein the response comprises an expiry code for the dynamic transaction code.

Clause 7. The method of any one of clauses 1-6, further comprising onboarding, by the merchant computer, the merchant information details to the alias directory.

Clause 8. The method of clause 7, wherein onboarding the merchant information details in the alias directory comprises: receiving, by the alias directory, a merchant payment option selection from the merchant computer; inserting, in the alias directory, account information related to the selected merchant payment option; and inserting, in the alias directory, merchant identification information.

Clause 9. The method of any one of clauses 1-8, wherein the dynamic transaction code is a dynamic quick response (QR) code.

Clause 10. A method of anonymously conducting a secured payment transaction between a consumer and a merchant, the method comprising: receiving, by a merchant website, a shopping cart checkout selection from a consumer device; initializing, by the merchant website, a dynamic transaction code widget; sending, by the dynamic transaction code widget, a merchant alias identifier and shopping cart checkout value to a dynamic transaction code engine; validating, by the dynamic transaction code engine, the merchant alias identifier in an alias directory; generating, by the dynamic transaction code engine, a dynamic transaction code; sending, by the dynamic transaction code engine, the dynamic transaction code to the dynamic transaction code widget; displaying, by the dynamic transaction code widget, the dynamic transaction code on an access device.

Clause 11. The method of clause 10, comprising scanning, the dynamic transaction code displayed on the access device with a consumer mobile device executing an issuer app.

Clause 12. The method of clause 11, comprising performing payment, by the consumer mobile device, based on the dynamic transaction code.

Clause 13. The method of any one of clauses 10-12, wherein the dynamic transaction code is a dynamic quick response (QR) code.

Clause 14. A method of anonymously conducting a secured payment transaction between a consumer and a merchant, the method comprising: presenting, by a merchant computer, a dynamic transaction code; scanning the dynamic transaction code by a consumer device executing a mobile app; initiating, by the mobile app, a transaction by sending dynamic transaction code data associated with the dynamic transaction code to an issuer computer; resolving, by the issuer computer, merchant details stored in an alias directory; initiating, by the issuer computer, merchant push payments to a payment processing network computer; and sending, by the payment processing network computer, transaction details to an acquirer computer.

Clause 15. The method of clause 14, comprising displaying, by the issuer computer, transaction status on the mobile app.

Clause 16. The method of clause 15, comprising querying, by the merchant computer, the transaction status via the payment processing network computer.

Clause 17. The method of clause 16, comprising displaying, by the merchant computer, order confirmation on the consumer device.

Clause 18. The method of any one of clauses 14-17, wherein the dynamic transaction code is a dynamic quick response (QR) code.

Clause 19. The method of clause 18, wherein the dynamic QR code comprises at least a unique dynamic QR code identifier and a merchant alias identifier.

Clause 20. The method of clause 19, wherein the dynamic QR code further comprises at least a merchant alias type, a transaction amount, a transaction currency code, a payment option, and an expiry code for the dynamic QR code.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A method of anonymously conducting a secured payment transaction between a consumer and a merchant, the method carried out at a transaction code computer in communication with an alias directory, the method comprising:
receiving, by a transaction code computer, a request for a dynamic transaction code from a merchant computer, wherein the request comprises a merchant alias identifier;
querying, by the transaction code computer, an alias directory storing merchant information details;
validating, by the transaction code computer, the merchant with the alias directory based on the merchant alias identifier;
generating, by the transaction code computer, the dynamic transaction code; and
transmitting, by the transaction code computer, a response to the request for the dynamic transaction code to the merchant computer.

2. The method of claim 1, wherein the request comprises transaction currency information.

3. The method of claim 2, wherein the request comprises transaction amount information.

4. The method of claim 1, wherein the response comprises a dynamic transaction code identifier.

5. The method of claim 4, wherein the response comprises a universal resource locator (URL) for the dynamic transaction code.

6. The method of claim 5, wherein the response comprises an expiry code for the dynamic transaction code.

7. The method of claim 1, further comprising onboarding, by the merchant computer, the merchant information details to the alias directory.

8. The method of claim 7, wherein onboarding the merchant information details in the alias directory comprises:
receiving, by the alias directory, a merchant payment option selection from the merchant computer;
inserting, in the alias directory, account information related to the selected merchant payment option; and
inserting, in the alias directory, merchant identification information.

9. The method of claim 1, wherein the dynamic transaction code is a dynamic quick response (QR) code.

10. A method of anonymously conducting a secured payment transaction between a consumer and a merchant, the method comprising:
receiving, by a merchant website, a shopping cart checkout selection from a consumer device;
initializing, by the merchant website, a dynamic transaction code widget;
sending, by the dynamic transaction code widget, a merchant alias identifier and shopping cart checkout value to a dynamic transaction code engine;
validating, by the dynamic transaction code engine, the merchant alias identifier in an alias directory;
generating, by the dynamic transaction code engine, a dynamic transaction code;
sending, by the dynamic transaction code engine, the dynamic transaction code to the dynamic transaction code widget; and
displaying, by the dynamic transaction code widget, the dynamic transaction code on an access device.

11. The method of claim 10, comprising scanning the dynamic transaction code displayed on the access device with a consumer mobile device executing an issuer app.

12. The method of claim 11, comprising performing payment, by the consumer mobile device, based on the dynamic transaction code.

13. The method of claim 10, wherein the dynamic transaction code is a dynamic quick response (QR) code.

14. A method of anonymously conducting a secured payment transaction between a consumer and a merchant, the method comprising:
presenting, by a merchant computer, a dynamic transaction code;
scanning the dynamic transaction code by a consumer device executing a mobile app;
initiating, by the mobile app, a transaction by sending dynamic transaction code data associated with the dynamic transaction code to an issuer computer;
resolving, by the issuer computer, merchant details stored in an alias directory;
initiating, by the issuer computer, merchant push payments to a payment processing network computer; and
sending, by the payment processing network computer, transaction details to an acquirer computer.

15. The method of claim 14, comprising displaying, by the issuer computer, transaction status on the mobile app.

16. The method of claim 15, comprising querying, by the merchant computer, the transaction status via the payment processing network computer.

17. The method of claim 16, comprising displaying, by the merchant computer, order confirmation on the consumer device.

18. The method of claim 14, wherein the dynamic transaction code is a dynamic quick response (QR) code.

19. The method of claim 18, wherein the dynamic QR code comprises at least a unique dynamic QR code identifier and a merchant alias identifier.

20. The method of claim 19, wherein the dynamic QR code further comprises at least a merchant alias type, a transaction amount, a transaction currency code, a payment option, and an expiry code for the dynamic QR code.
